(19) United States
(12) Patent Application Publication
(10) Pub. No.: US 2008/0191672 A1
(43) Pub. Date: Aug. 14, 2008

(54) Voltage-stabilizing circuit in power supply apparatus of automobiles

(76) Inventor: Yung Sheng Huang, Taipei County (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/715,433

(22) Filed: Mar. 8, 2007

(30) Foreign Application Priority Data
Feb. 9, 2007 (TW) 096202519

(51) Int. Cl. G05F 1/00

(52) U.S. Cl. 323/274

(57) ABSTRACT

The present invention related to a voltage-stabilizing circuit in the power supply apparatus of automobiles, and comprising a battery, a voltage-stabilizing capacitor, and a switching circuit. The battery provides a voltage; the voltage-stabilizing capacitor couples to the battery, and stabilizes the output voltage of the power supply apparatus of the automobiles; and the switching circuit opens the circuit between the voltage-stabilizing capacitor and the battery when the voltage of the battery is detected to be smaller than a threshold value. Thereby, power consumption of the battery is reduced, and the voltage-stabilizing capacitor is protected and thus the lifetime thereof is lengthened.

### FIELD OF THE INVENTION

The present invention relates generally to a voltage-stabilizing circuit, and particularly to a voltage-stabilizing circuit in the power supply apparatus of automobiles.

### BACKGROUND OF THE INVENTION

Modern technologies progress and develop continuously. In particular, the electronic industry brings more convenience to the general public, for example, mobile phones and personal digital assistants (PDAs). With the advancement of the electronic industry, many manufacturers in the electronic industry develop towards applications in automobiles. For example, global positioning system (GPS), start-up circuitry of automobiles, or fuel-saving devices enhances convenience in the operation of automobiles.

In general start-up circuitry of automobiles, a battery is used to supply electricity to a generator to start the start-up mechanism of an automobile. After the automobile is started and when the voltage value generated by the generator is greater than that of the battery, electricity is charged to the battery. However, when the automobile is going uphill, accelerating abruptly, or running at high speed, instantaneous electricity and pulse produced by the generator is not sufficient to supply electricity demanded by the ignition coils and sensors. In general, there are 8 to 15 sensors in the engine of an automobile to sense intake airflow, piston position, battery voltage, crank angle, fuel injection condition, and oxygen concentration in the exhaust pipe, etc. Thereby, the automobile will experience deficiency of power when climbing hills, be incapable of accelerate abruptly, or be unable to speed up.

Accordingly, some manufacturers use the compensation principle of reverse current for voltage stabilization. That is, a capacitor parallels between the car battery and the generator to provide components and equipments of automobiles, such as the battery, the engine fuel-injection computer, the generator, and the audio system, with a good and stable operating voltage. In addition, the voltage of the battery and the circuits of the power system will not be affected by the throttle and the rotational rate of the engine.

FIG. 1 shows a block diagram of the voltage-stabilizing and protection apparatus for automobiles according to Taiwan Patent No. M289927. As shown in the figure, the voltage-stabilizing and protection apparatus for automobiles 1′ includes a power fuse 10′, a series capacitor network for reverse current 20′, a capacitor function display 30′, a voltage detection and display unit 40′, and a power break and protection device 50′. The power fuse 10′ is composed of a plurality of capacitors, and is coupled to a car battery 2′. The series capacitor network for reverse current 20′ is in series with a plurality of capacitors, and is couple to the power fuse 10′. In addition, the series capacitor network for reverse current 20′ provides instantaneous voltage feedback compensation by reverse current to the car battery 2′. The capacitor function display 30′ couples to the series capacitor network for reverse current 20′ for detecting and displaying the working status of the capacitors in the series capacitor network for reverse current 20′. The voltage detection and display unit 40′ is coupled between the series capacitor network for reverse current 20′ and the capacitor function display 30′ for detecting and displaying the wire voltage of the series capacitor network for reverse current 20′, and for receiving the detection results of the working status of the capacitors in the series capacitor network for reverse current 20′ by the capacitor function display 30′. The power break and protection device 50′ couples to the series capacitor network for reverse current 20′ and the voltage detection and display unit 40′ for breaking the power between the series capacitor network for reverse current 20′ and the car battery 2′ according to the working status of the capacitors in the series capacitor network for reverse current 20′ detected by the voltage detection and display unit 40′ and when the wire voltage of the series capacitor network for reverse current 20′ drops down close to the rated voltage of the car battery 2′.

The objective of the protection apparatus described above is to prevent damage caused by short circuit of the capacitor with smaller capacitance in parallel with the series capacitor network for reverse current 20′. If this occurs, large instantaneous current will flow back to the car battery 2′ and damage the car battery 2′. Nevertheless, because the series capacitor network for reverse current 20′ is coupled to the car battery 2′ by the power fuse 10′, no matter if the automobile starts the series capacitor network for reverse current 20′, power in the car battery 2′ will be consumed. Besides, long-term connection of the series capacitor network for reverse current 20′ with the car battery 2′ shortens lifetime of the capacitors.

Accordingly, a novel voltage-stabilizing circuit in the power supply apparatus of automobiles is provided to solve the problems described above. It not only can reduce consumption of power in car batteries, but also can increase lifetime of capacitors.

### SUMMARY

An objective of the present invention is to provide a voltage-stabilizing circuit in the power supply apparatus of automobiles, which sets a threshold value to control the circuit between the battery and the voltage-stabilizing capacitor according to the voltage difference of the battery between start-up and rest of engines of the automobiles. Thereby, power consumption of the battery can be reduced.

Another objective of the present invention is to provide a voltage-stabilizing circuit in the power supply apparatus of automobiles, which sets a threshold value to control the circuit between the battery and the voltage-stabilizing capacitor according to the voltage difference of the battery between start-up and rest of engines of the automobiles. Thereby, the voltage-stabilizing capacitor can be protected and hence the lifetime thereof can be increased.

A further objective of the present invention is to provide a voltage-stabilizing circuit in the power supply apparatus of automobiles, which has a discharging circuit for discharging the voltage-stabilizing capacitor when engines are at rest. Thereby, polarization phenomenon can be prevented and hence the lifetime of the voltage-stabilizing capacitor can be increased.

The voltage-stabilizing circuit in the power supply apparatus of automobiles according to the present invention comprises a battery, a voltage-stabilizing capacitor, and a switching circuit. The battery provides a voltage; the voltage-stabilizing capacitor couples to the battery; and the switching circuit opens the circuit between the voltage-stabilizing capacitor and the battery when the voltage of the battery is detected to be smaller than a threshold value.

In addition, the voltage-stabilizing circuit in the power supply apparatus of automobiles further comprises a discharging device, which is coupled between the switching circuit and the voltage-stabilizing capacitor. When the voltage of the battery is detected to be smaller than the threshold value by the switching circuit, the discharging device and the voltage-stabilizing capacitor form a discharging circuit.

### BRIEF DESCRIPTION OF THE DRAWINGS

FIG. 1 shows a block diagram of the voltage-stabilizing and protection apparatus for automobiles according to the prior art;

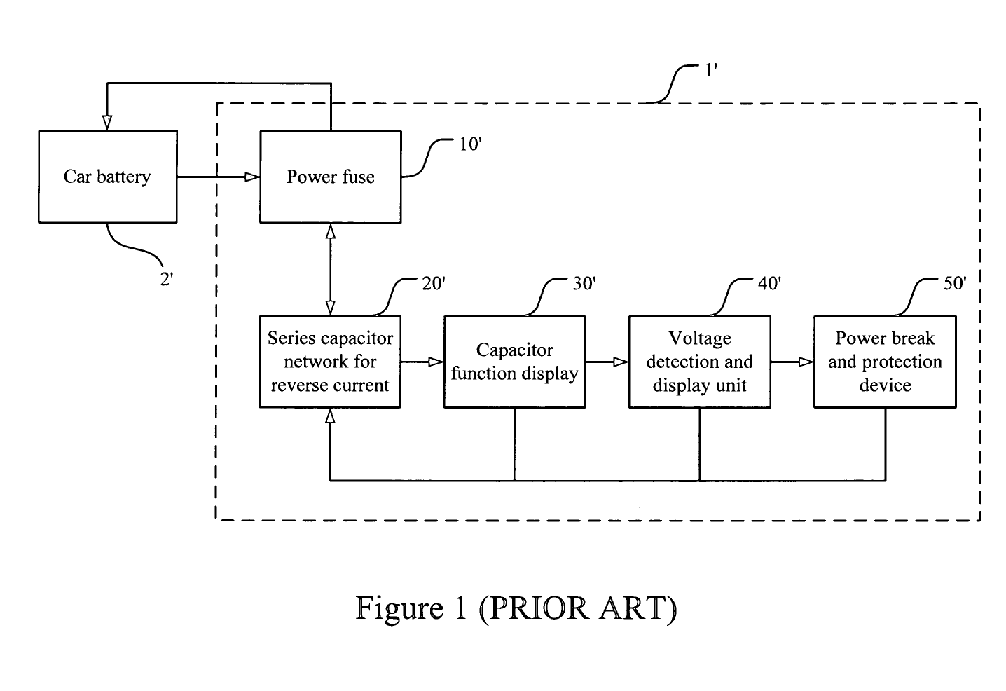

FIG. 2 shows a block diagram according to a preferred embodiment of the present invention;

FIG. 3 shows another block diagram according to another preferred embodiment of the present invention; and

FIG. 4 shows another block diagram according to another preferred embodiment of the present invention.

### DETAILED DESCRIPTION

In order to make the structure and characteristics as well as the effectiveness of the present invention to be further understood and recognized, the detailed description of the present invention is provided as follows along with preferred embodiments and accompanying figures.

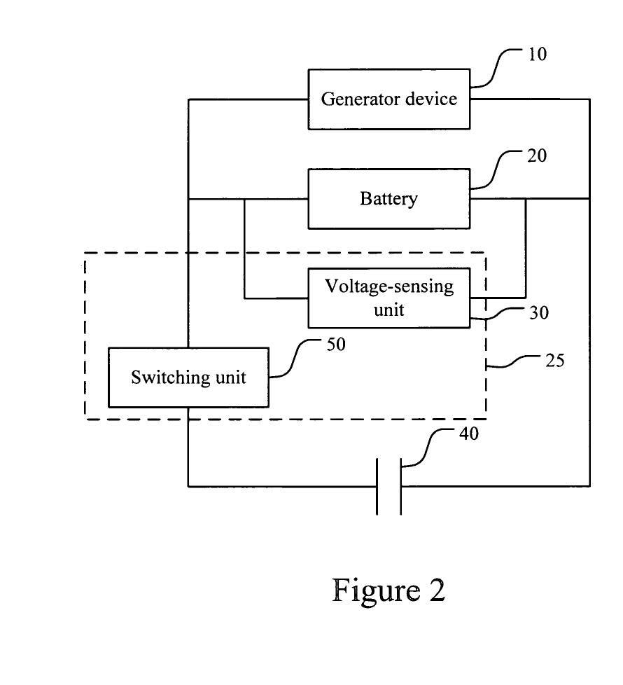

FIG. 2 shows a block diagram according to a preferred embodiment of the present invention. As shown in the figure, the voltage-stabilizing circuit in the power supply apparatus of automobiles according to the present invention comprises a generator device 10, a battery 20, a switching circuit 25, and a voltage-stabilizing capacitor 40. The generator device 10 supplies power to components and equipments of automobiles, such as power mechanisms, engine fuel-injection computers, and audio systems, when the automobiles start up. The battery 20 is coupled to the generator device 10 for supplying power to the generator device 10 when the engines of the automobiles start up. The generator device 10 receives the power of the battery 20. When the voltage of the generator device 10 is greater than the voltage of the battery 20, the battery 20 is charged. The battery 20 is a car battery used for charging and discharging.

The voltage-stabilizing capacitor 40 couples to the battery 20 for stabilizing the output voltage of the power supply apparatus of automobiles. In addition to supplying engines of the automobiles, the battery 20 can also perform discharge compensation when power consumption increases due to heavy loads (for example, going uphill, or accelerating abruptly). However, the voltage-stabilizing effect of the battery 20 alone is quite limited. Because the battery 20 is composed of a plurality of lead electrodes and electrolyte, the contact area of the lead electrodes and the electrolyte is not large. Thereby, the charging and discharging effect is limited. When the automobiles go uphill, accelerate abruptly, or run at high speed, the instantaneous power and pulses produced by the generator device 10 is insufficient for the power demanded by ignition coils and sensors under such driving conditions. Hence, the voltage-stabilizing capacitor 40 can be used to compensate the power of the generator device 10 under the driving conditions described above for enhancing voltage-stabilizing effect. The voltage-stabilizing capacitor 40 is a supercapacitor, which is a single capacitor with capacitance as high as over 1000000 μF. Besides, a supercapacitor can release a great amount of current without the need of connecting a plurality of supercapacitors in parallel for increasing capacitance. Accordingly, the number of components used according to the present invention is quite few. Thus, the failure probability of the voltage-stabilizing capacitor 40 is reduced.

The switching circuit 25 is coupled between the battery 20 and the voltage-stabilizing capacitor 40, and detects the voltage of the battery 20. When the voltage of the battery 20 is smaller than a threshold value, the circuit between the voltage-stabilizing capacitor 40 and the battery 20 is opened. There exists a voltage difference on the battery 20 between engine start-up and rest. That is, when the engine starts, the voltage of the battery 20 is 13.5 to 14 volts. On the other hand, when the engine is at rest, the voltage of the battery 20 is 12.5 volts. Thereby, by setting the threshold value between 12.8 and 13.2 volts, when the voltage of the battery 20 is detected to be smaller than the threshold value by the switching circuit 25, the switching circuit 25 opens the circuit between the voltage-stabilizing capacitor 40 and the battery 20. When the voltage of the battery 20 is greater than the threshold value, the circuit between the voltage-stabilizing capacitor 40 and the battery 20 is closed to make the voltage-stabilizing capacitor 40 enhance the voltage-stabilizing effect of automobiles. Thereby, when the engine starts, the voltage-stabilizing capacitor 40 stabilizes the output voltage of the power apparatus of automobiles. When the engine is at rest, no action is needed. Under such a mechanism, the voltage-stabilizing capacitor 40 needs not to couple to the battery 20 all the time. Consequently, power consumption of the battery 20 is reduced, and thus power is saved. In addition, the voltage-stabilizing capacitor 40 is protected, and hence the lifetime thereof is increased.

The switching circuit 25 further includes a voltage-sensing unit 30 and a switching unit 50. The voltage-sensing unit 30 is in parallel with the battery 20 for detecting the voltage of the battery 20. When the voltage of the battery 20 is smaller than a threshold value, a sensing signal is produced. For normal batteries, when the engine starts, the voltage of the battery 20 is 13.5 to 14 volts. On the other hand, when the engine is at rest, the voltage of the battery 20 is 12.5 volts. Thereby, by setting the threshold value between 12.8 and 13.2 volts, when the voltage of the battery 20 is detected to be smaller than the threshold value by the switching unit 30, the sensing signal is produced.

The switching unit 50 is coupled between the battery 20 and the voltage-stabilizing capacitor 40. When the sensing signal is received, the circuit between the battery 20 and the voltage-stabilizing capacitor 40 is opened. Furthermore, the switching unit is an electronic switch for controlling the circuit between the battery 20 and the voltage-stabilizing capacitor 40. The electronic switch can be a Metal-Oxide-Semiconductor Field-Effect Transistor (MOSFET).

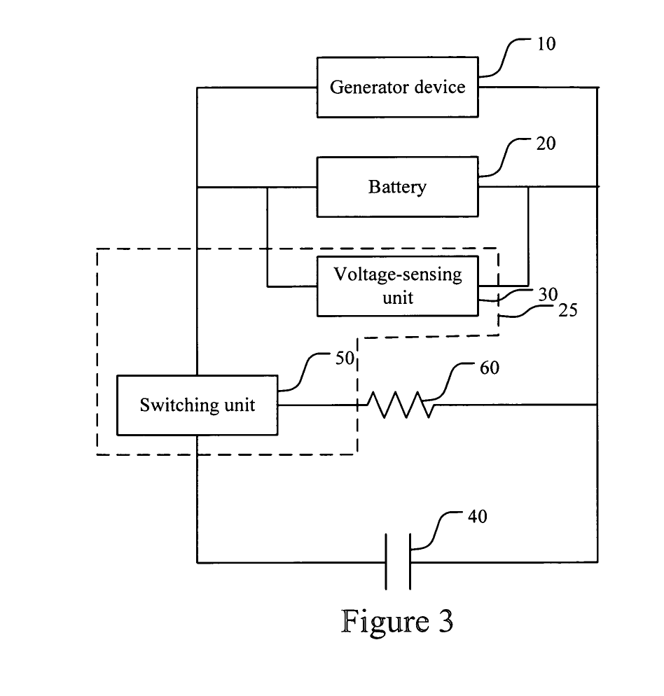

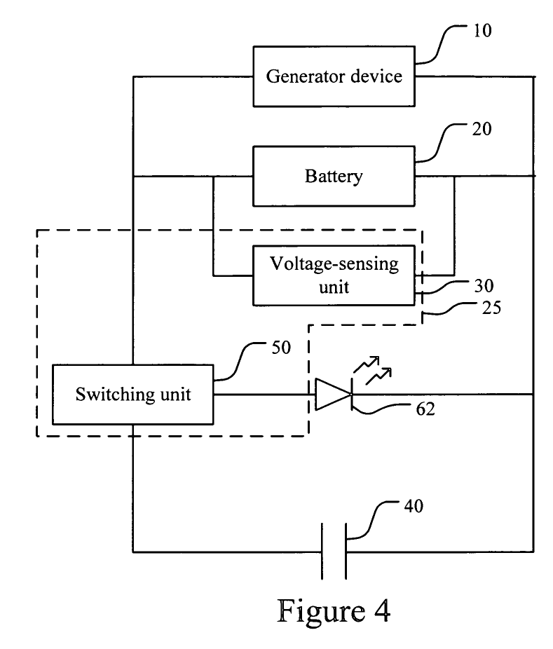

The voltage-stabilizing capacitor 40 is long-termly coupled to the battery 20, and is charged and discharged when the engine of the automobile starts and rests. In addition, the voltage-stabilizing capacitor 40 does not usually discharge to 0 volt. Thereby, polarization phenomenon occurs in the voltage-stabilizing capacitor 40 and hence the lifetime thereof is shortened. FIG. 3 and FIG. 4 show other block diagrams according to other preferred embodiments of the present invention. As shown in the figure, the difference between the preferred embodiment of the voltage-stabilizing circuits in power supply apparatus of automobiles in FIGS. 3 and 4 and that of FIG. 2 is that a discharging device is further included. The discharging device is coupled between the switching unit 50 and the voltage-stabilizing capacitor 40. When the voltage sensed by the voltage-sensing unit 30 is smaller than the threshold value, the switching unit 50 makes the discharging device and the voltage-stabilizing capacitor 40 form a discharging circuit.

Besides, the discharging device is an impedance device. As shown in FIG. 3, a resistor 60 is used as the discharging device. When the voltage of the battery 20 is smaller than the threshold value, the switching unit 50 will switch the circuit to make the resistor and the voltage-stabilizing capacitor form a discharging circuit for discharging instantaneously the voltage of the voltage-stabilizing capacitor to 0 volt. Thereby, lifetime shortening due to polarization phenomenon in the voltage-stabilizing capacitor 40 can be avoided. Likewise, the discharging device can be a Light-Emitting Diode (LED). As shown in FIG. 4, when the LED 62 and the voltage-stabilizing capacitor 40 form a discharging circuit, the voltage-stabilizing capacitor 40 will discharge by way of the LED 62, and users will be informed that the voltage-stabilizing capacitor 40 is discharging.

In addition, the switching unit 50 can be a mechanical switch, such as a relay, for controlling the circuit between the voltage-stabilizing capacitor 40 and the battery 20. When the voltage of the battery 20 is smaller than the threshold value, the relay will switch the circuit between the voltage-stabilizing capacitor 40 and the battery 20 to the discharging circuit.

To sum up, the voltage-stabilizing circuit in the power supply apparatus of automobiles according to the present invention opens the circuit between the voltage-stabilizing capacitor and the battery by the switching unit when the voltage-sensing unit detects the voltage of the battery to be smaller than the threshold value. Thereby, power consumption of the battery is reduced, and the voltage-stabilizing capacitor is protected and thus the lifetime thereof is lengthened. Besides, a discharging circuit is further disposed according to the present invention for preventing polarization phenomenon in the voltage-stabilizing capacitor, and hence the lifetime of the voltage-stabilizing capacitor is increased.

Accordingly, the present invention conforms to the legal requirements owing to its novelty, non-obviousness, and utility. However, the foregoing description is only a preferred embodiment of the present invention, not used to limit the scope and range of the present invention. Those equivalent changes or modifications made according to the shape, structure, feature, or spirit described in the claims of the present invention are included in the appended claims of the present invention.

1. A voltage-stabilizing circuit in the power supply apparatus of automobiles, comprising:
a battery, providing a voltage;
a voltage-stabilizing capacitor, coupled to the battery; and
a switching circuit, coupled between the battery and the voltage-stabilizing capacitor, and opening the circuit between the battery and the voltage-stabilizing capacitor when the voltage is detected to be smaller than a threshold value.

2. The voltage-stabilizing circuit in the power supply apparatus of automobiles of claim 1, and further comprising a generator device, coupled to the battery, started by receiving the voltage of the battery when the engines of the automobiles starts, and supplying voltage to the engines of the automobiles.

3. The voltage-stabilizing circuit in the power supply apparatus of automobiles of claim 1, wherein the switching circuit makes the voltage-stabilizing capacitor and the battery form a circuit when the voltage is greater than the threshold value.

4. The voltage-stabilizing circuit in the power supply apparatus of automobiles of claim 1, and further comprising a discharging device, coupled between the switching circuit and the voltage-stabilizing capacitor, and the switching circuit making the discharging device and the voltage-stabilizing capacitor form a discharging circuit when the voltage is detected to be smaller than the threshold value.

5. The voltage-stabilizing circuit in the power supply apparatus of automobiles of claim 4, wherein the discharging device is an impedance device.

6. The voltage-stabilizing circuit in the power supply apparatus of automobiles of claim 5, wherein the impedance device is a resistor or a Light-Emitting Diode (LED).

7. The voltage-stabilizing circuit in the power supply apparatus of automobiles of claim 1, wherein the voltage-stabilizing capacitor is a supercapacitor.

8. The voltage-stabilizing circuit in the power supply apparatus of automobiles of claim 1, wherein the switching circuit further comprises:
a voltage-sensing unit, coupled to the battery, and producing a sensing signal when the voltage is detected to be smaller than the threshold value; and
a switching unit, receiving the sensing signal and opening the circuit between the voltage-stabilizing capacitor and the battery.

9. The voltage-stabilizing circuit in the power supply apparatus of automobiles of claim 8, wherein the switching unit is an electronic switch.

10. The voltage-stabilizing circuit in the power supply apparatus of automobiles of claim 9, wherein the electronic switch is a Metal-Oxide-Semiconductor Field-Effect Transistor (MOSFET).

11. The voltage-stabilizing circuit in the power supply apparatus of automobiles of claim 8, wherein the switching unit is a mechanical switch.

12. The voltage-stabilizing circuit in the power supply apparatus of automobiles of claim 11, wherein the mechanical switch is a relay.

13. The voltage-stabilizing circuit in the power supply apparatus of automobiles of claim 1, wherein the threshold value can be set between 12.8 and 13.2 volts.

14. The voltage-stabilizing circuit in the power supply apparatus of automobiles of claim 1, wherein the battery is a car battery.
